(19) United States
(12) Patent Application Publication
(10) Pub. No.: US 2017/0055457 A1
(43) Pub. Date: Mar. 2, 2017

(54) Power Transmission Couplers And Bale Processors Using Same

(71) Applicant: Vermeer Manufacturing Company, Pella, IA (US)

(72) Inventors: Phil Stam, Pella, IA (US); Tyler Schiferl, Pella, IA (US); Lucas Graham, New Sharon, IA (US)

(21) Appl. No.: 14/841,235

(22) Filed: Aug. 31, 2015

(51) Int. Cl. A01F 29/09; A01D 87/00; F16D 11/14; A01F 29/00

(52) U.S. Cl. CPC A01F 29/09; A01F 29/005; A01D 87/0007; F16D 11/14

(57) ABSTRACT

Disconnect systems for use in power transmission components and systems are provided. Such disconnect systems may be utilized in various applications, and bale processors using such disconnect systems are disclosed. One disconnect system is provided for selectively transmitting force between first and second shafts. The disconnect system includes a first closure configured to rotate with the first shaft, and a second closure configured to rotate with the second shaft. The second closure is movable along the second shaft to selectively engage the first closure, and the second closure has a detent respectively operable with proximal and distal depressions of the second shaft. The first and second closures are engaged with one another when the detent operates with the proximal depression, and are disengaged from one another when the detent operates with the distal depression. Respective operation of the detent with the proximal and distal depressions biases the second closure from moving along the second shaft.

### BACKGROUND

The current invention relates generally to power transmission components and systems, and more particularly to couplers for use in power transmission components and systems. Such couplers may be utilized in various applications, and in some embodiments the current invention relates to bale processors.

Bale processors are devices used to spread the content of bales of bale filamentary material in a controlled way for reasons such as mulching or feeding livestock. Examples of bale processors are shown in U.S. patent application Ser. No. 14/290,558, filed by Vermeer Manufacturing Company on May 29, 2014; PCT/US2013/023153, filed by Vermeer Manufacturing Company, published as WO2013/112841; and PCT/US2011/058514, filed by Vermeer Manufacturing Company, published as WO2013/066287. Each of those publications are incorporated herein by reference in their entirety—and form part of—the current disclosure. A copy of U.S. patent application Ser. No. 14/290,558 is provided with the Information Disclosure Statement accompanying this application, and is therefore publicly available and easily accessible for posterity through the United States Patent & Trademark Office.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

According to one embodiment, a disconnect system is provided for selectively transmitting force between first and second shafts. The disconnect system includes first and second closures. The first closure is configured to rotate with the first shaft, and the second closure is configured to rotate with the second shaft. The second closure is movable along the second shaft to selectively engage the first closure, and the second closure has a detent respectively operable with proximal and distal depressions of the second shaft. The first and second closures are engaged with one another when the detent operates with the proximal depression, and the first and second closures are disengaged from one another when the detent operates with the distal depression. Respective operation of the detent with the proximal and distal depressions biases the second closure from moving along the second shaft.

According to another embodiment, a bale processor includes a hopper for receiving a bale of baled material, a discharge opening for outputting chopped material; a processing section, and a disconnect system for selectively transmitting force between first and second shafts. The processing section has primary and secondary rotors. The primary rotor has an axis of rotation and is rotatable to chop the material from the bale received in the hopper. The secondary rotor is rotatable to chop the material after being chopped by the primary rotor, and the secondary rotor is offset from the primary rotor such that the primary rotor is between the secondary rotor and the discharge opening. The disconnect system has first and second closures and a partition. The first closure is fixed along and rotatable with the first shaft. The second closure is rotatable with the second shaft and is movable along the second shaft such that the first and second closures selectively engage one another. Engagement of the first and second closures causes rotation of the first shaft to be transmitted to the second shaft, whereby the secondary rotor is operable. Rotation of the first shaft is not transmitted to the second shaft when the first and second closures are disengaged from one another. The partition is movable between a dividing position and a neutral position. The second closure is movable along the second shaft when the partition is at the neutral position, and the partition is between the first and second closures such that the first and second closures cannot be engaged with one another when the partition is at the dividing position.

According to still another embodiment, a bale processor includes a hopper for receiving a bale of baled material, a discharge opening for outputting chopped material; a processing section, and a disconnect system for selectively transmitting force between first and second shafts. The processing section has primary and secondary rotors. The primary rotor has an axis of rotation and is rotatable to chop the material from the bale received in the hopper. The secondary rotor is rotatable to chop the material after being chopped by the primary rotor, and the secondary rotor is offset from the primary rotor such that the primary rotor is between the secondary rotor and the discharge opening. The disconnect system has first and second closures. The first closure is fixed along and rotatable with the first shaft. The second closure is rotatable with the second shaft and is movable along the second shaft such that the first and second closures selectively engage one another. Engagement of the first and second closures causes rotation of the first shaft to be transmitted to the second shaft, whereby the secondary rotor is operable. Rotation of the first shaft is not transmitted to the second shaft when the first and second closures are disengaged from one another. The second shaft has proximal and distal depressions, and the second closure has a detent respectively operable with the proximal and distal depressions. The first and second closures are engaged with one another when the detent operates with the proximal depression, and the first and second closures are disengaged from one another when the detent operates with the distal depression. Respective operation of the detent with the proximal and distal depressions biases the second closure from moving along the second shaft.

According to still yet another embodiment, a disconnect system for selectively transmitting force between first and second shafts includes a first closure configured to rotate with the first shaft, and a second closure configured to rotate with the second shaft, the second closure being movable along the second shaft to selectively engage the first closure. The first shaft and the second shaft may be axially misaligned. To correct for the axial misalignment, the second closure comprises a snap ring which is configured to allow the second closure to adjust in a radial direction on the second shaft when the second closure selectively engages the first closure. Further, the second closure has a detent respectively operable with proximal and distal depressions of the second shaft. The first and second closures are engaged with one another when the detent operates with the proximal depression. The first and second closures are disengaged from one another when the detent operates with the distal depression. Respective operation of the detent with the proximal and distal depressions bias the second closure from moving along the second shaft.

### BRIEF DESCRIPTION OF THE DRAWINGS

FIG. 1 shows a bale processor according to one embodiment of the current invention.

FIG. 2 is a section view taken at line 2-2 of FIG. 1, with a secondary rotor engaged according to one embodiment of the invention.

FIG. 2a is a section view taken at line 2-2 of FIG. 1, with a secondary rotor engaged according to another embodiment of the invention.

FIG. 3 is a section view taken at line 2-2 of FIG. 1, with the secondary rotor disengaged according to the embodiment of FIG. 2.

FIG. 3a is a section view taken at line 2-2 of FIG. 1, with the secondary rotor disengaged according the embodiment of FIG. 2a.

FIG. 4 shows structure for moving an internal deflector, according to an embodiment of the current invention.

FIG. 4a shows structure for moving an internal deflector, according to another embodiment of the current invention.

FIG. 5a shows primary and secondary intermeshing rotors according to an embodiment of the current invention.

FIG. 5b is a side view of FIG. 5a.

FIG. 6a shows primary and secondary non-intermeshing rotors according to another embodiment of the current invention.

FIG. 6b is a side view of FIG. 6a.

FIG. 7a is a perspective view of a power transmission disconnect system incorporated in the bale processor of FIG. 1, according to one embodiment of the current invention and with the disconnect system at an engaged position.

FIG. 7b is another perspective view of the disconnect system of FIG. 7a, with the disconnect system at the engaged position.

FIG. 7c is a section view of the disconnect system of FIG. 7a, with the disconnect system at the engaged position.

FIG. 8a is a perspective view of the disconnect system of FIG. 7a, with the disconnect system at an intermediate disengaged position.

FIG. 8b is another perspective view of the disconnect system of FIG. 7a, with the disconnect system at the intermediate disengaged position.

FIG. 9a is a perspective view of the disconnect system of FIG. 7a, with the disconnect system at a disengaged position.

FIG. 9b is another perspective view of the disconnect system of FIG. 7a, with the disconnect system at the disengaged position.

FIG. 9c is a section view of the disconnect system of FIG. 7a, with the disconnect system at the disengaged position.

FIG. 10 is a perspective view of the disconnect system of FIG. 7a, in context of the bale processor of FIG. 1 and with the internal deflector lowering from the raised position to the lowered position.

FIG. 11 is a perspective view of the disconnect system of FIG. 7a, in context of the bale processor of FIG. 1 and with the internal deflector lowered.

### DETAILED DESCRIPTION

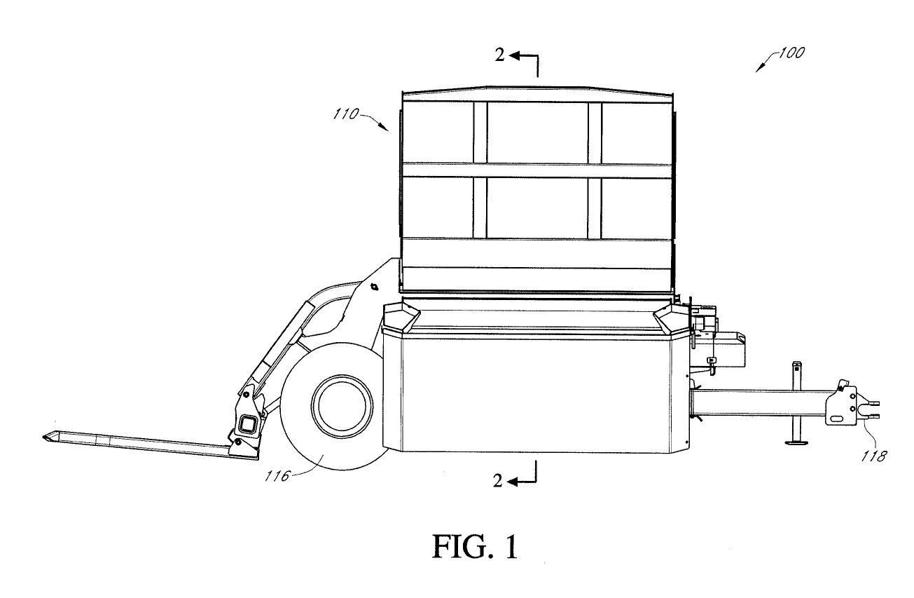

FIGS. 1 through 3 illustrate a bale processor 100, according to one embodiment. The bale processor 100 includes a hopper (or “tub”) 110 for receiving bale of forage, bedding, or another bale filamentary material (e.g., hay, straw, corn stover, etc.); a processing section 120 that includes primary and secondary rotors 130, 140; and a discharge opening 160 for outputting processed (or “chopped”) bale filamentary material. The terms “primary” and “secondary” are used herein for convenience in referring to the rotors 130, 140 and indicate that the bale filamentary material interacts with the rotor 130 before interacting with the rotor 140 (as described in detail below).

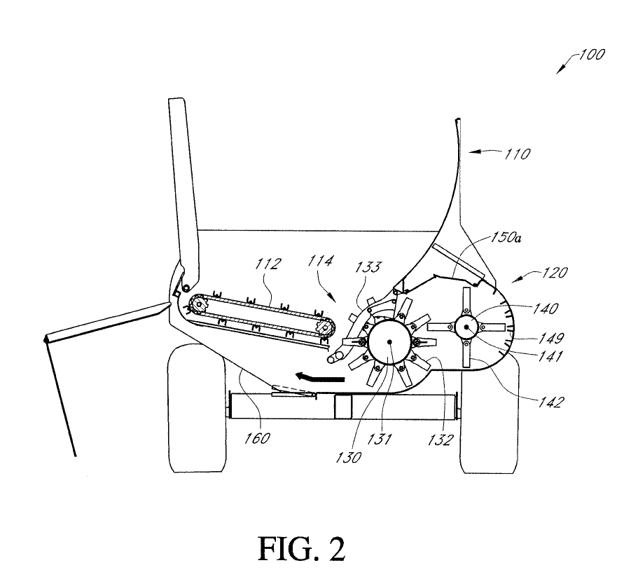

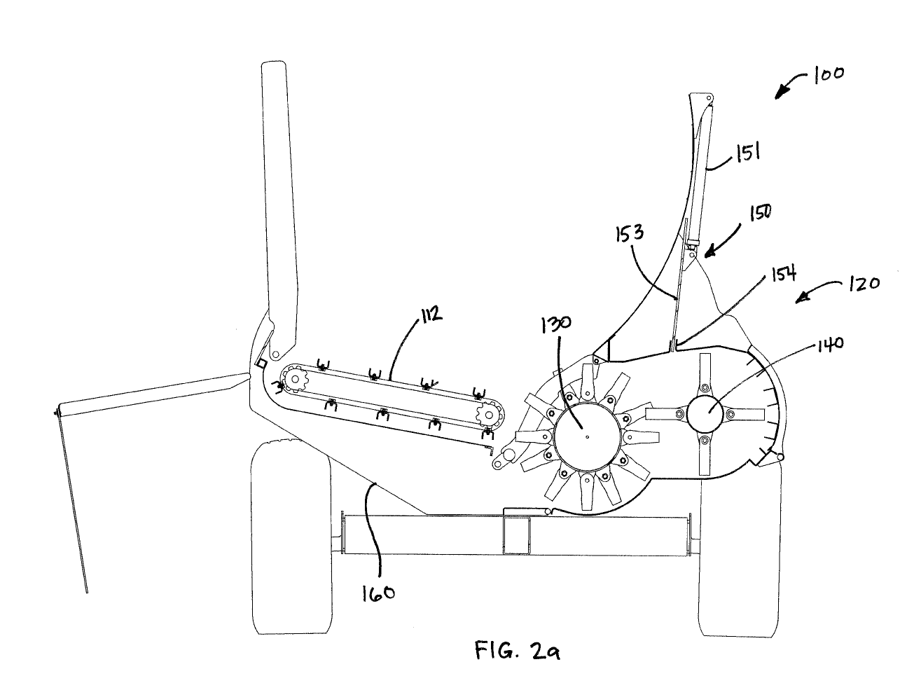

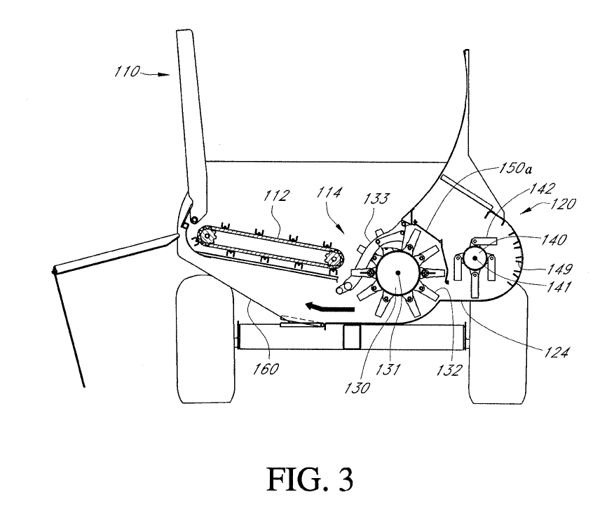

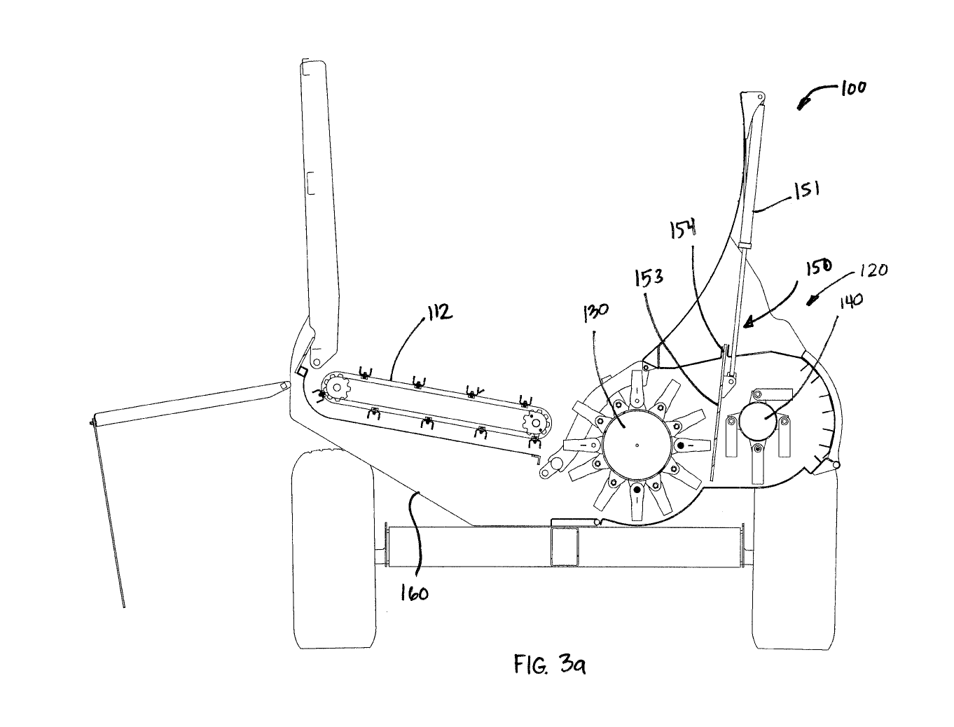

The hopper 110 of embodiment 100 is consistent with “hopper 12” of WO2013/066287. However, as will be appreciated by those skilled in the art, the hopper 110 may be of various configurations, shapes, and sizes. A conveyor 112, as shown in FIGS. 2 and 3, may be included in the hopper 110 to rotate a bale inside the hopper 110. The conveyor 112 of embodiment 100 and its means of operation are consistent with “chain conveyor 16” and the accompanying disclosure in WO2013/066287. But especially since various conveyors are well known, those skilled in the art will understand that alternate types of conveyors and ways of powering conveyors—whether now known or later developed—may be utilized. Further, “conveyor” is used broadly herein to include any various elements (e.g., rotatable wheels and cams) capable of rotating bales inside the hopper 110.

As shown in the drawings, the bale processor 100 may include elements for allowing travel and transport thereof—e.g., wheels 116 and hitch 118. Mobility may not be desirable in all cases, however, and stationary embodiments are clearly contemplated herein.

Attention is now directed to the processing section 120 (FIGS. 2, 2a, 3 and 3a). The primary rotor 130 is positioned to interact with (i.e., chop) the bale in the hopper 110, preferably—though not necessarily—as the bale rotates due to the conveyor 112. Directions of the primary rotor 130 and the conveyor 112 can each change as desired, but the default direction of both when looking at FIGS. 2, 2a, 3 and 3a is clockwise.

The primary rotor 130 may have various cutting configurations for cutting bale filamentary material, whether now known or later developed. In embodiment 100, the primary rotor 130 is consistent with “flail rotor 14” of WO2013/066287. Moreover, at least one control/slug bar 133 consistent with the “depth control bars/slugs 18” of WO2013/066287 is included in embodiment 100 for controlling the distance that an outer end of the rotor 130 extends into an outer surface of a bale in the hopper 110.

Clockwise rotation (in FIGS. 2 and 3) of the primary rotor 130 chops bale filamentary material from a bale in the hopper 110 in an impingement zone 114—as described regarding operation of the “flail rotor 14” in WO2013/066287. But instead of the chopped bale filamentary material always directly exiting the bale processor through a discharge opening once chopped, bale filamentary material in the bale processor 100 may advance in a direction away from the discharge opening 160 to the secondary rotor 140.

The secondary rotor 140 is laterally offset from the primary rotor 130, and it may be desirable for an axis 141 of the secondary rotor 140 to be generally parallel to and higher than an axis 131 of the primary rotor 130 (FIG. 2). Moreover, it may be desirable for the processing section 120 to have a wall 124 extending generally horizontally at least from a point below the axis 141 to a point past extended flails 132 of the primary rotor 140, as shown in FIG. 3.

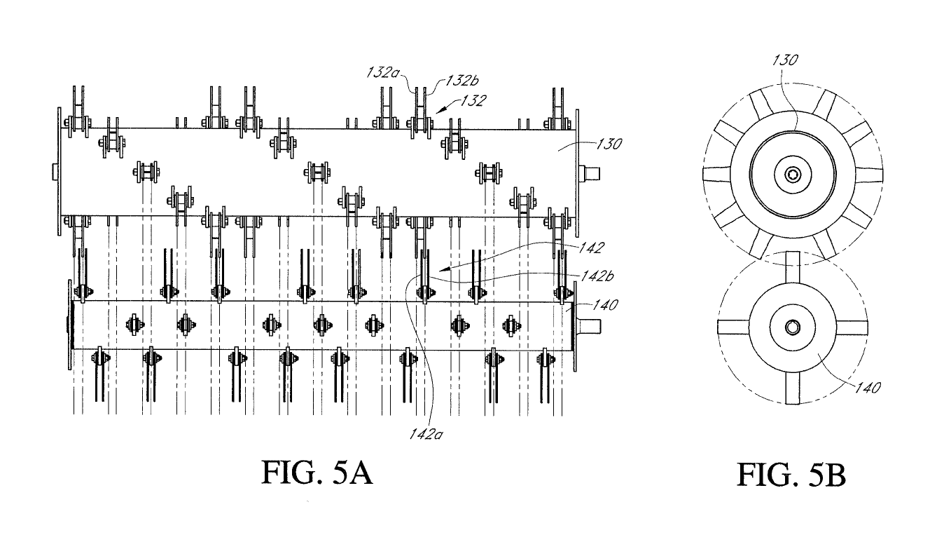

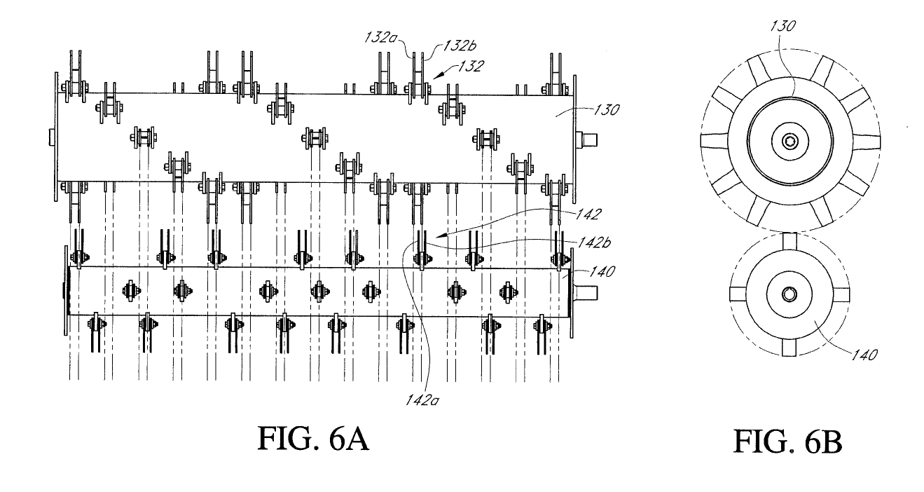

As with the primary rotor 130, the secondary rotor 140 may be configured in various ways to cut bale filamentary material. In some embodiments, the secondary rotor 140 intermeshes with the primary rotor 130 when in use; in other embodiments, the rotors 130, 140 are non-intermeshing. An example intermeshing arrangement is shown in FIGS. 5a and 5b, and an example non-intermeshing arrangement is shown in FIGS. 6a and 6b. Intermeshing may increase the transfer of bale filamentary material between the rotors 130, 140.

In both FIG. 5a and FIG. 6a, flails 132 have a one-piece design with two blades 132a, 132b. Flails 142 are similarly shown having two blades 142a, 142b; and while FIGS. 5a and 6a do not show blades 142a, 142b in a one-piece design (instead, the blades 142a, 142b are individual, free swinging blades mounted on either side of a common pivot, such as by a common bolt), a one-piece design may nevertheless be used. While two blades are not required in all embodiments, they may provide increased mass and stability over a single blade, and may lose less energy (and therefore put more energy into a cutting action) than a single blade. Further, a two-blade intermeshing arrangement may provide still improved transfer of bale filamentary material between the rotors 130, 140. For example, the intermeshing arrangement may reduce the distance that bale filamentary material must travel unassisted, greatly reducing the probability of wet material sticking or stopping forward travel (causing a plugged condition).

Rasp bars 149 may be adjacent the secondary rotor 140 to agitate material rotated by the secondary rotor 140, increasing the chopping effectiveness of the secondary rotor 140. Additionally, or alternately, rasp bars may be formed with or coupled to the secondary rotor 140 (such as protrusions from a twelve o'clock position to a six o'clock position along the secondary rotor 140, for example) to keep the bale filamentary material agitated and thus chopped multiple times.

Gearing or other power-transmitting devices (e.g., belts and pulleys, chains and sprockets, etc.) may allow a single motor to power both the primary rotor 130 and the secondary rotor 140 (and further the conveyor 112), though multiple motors or other rotation-inducing devices may be used. Further, while the secondary rotor 140 may rotate opposite the primary rotor 130, it may be desirable for both to rotate in the same direction (e.g., clockwise in FIG. 2). In the embodiment 100, the secondary rotor 140 is smaller than the primary rotor 130 and rotates at a higher RPM. It may be desirable for the secondary rotor 140 to rotate at least fifty percent faster than the primary rotor 130, even more desirable for the secondary rotor 140 to rotate at least eighty-five percent faster than the primary rotor 130, and even still more desirable for the secondary rotor 140 to rotate at least twice as fast as the primary rotor 130. For example, the primary rotor 130 may rotate at approximately 1500 RPM and the secondary rotor 140 may rotate at approximately 3000 RPM. In commercial embodiments of the bale processor in WO2013/066287, rotation of the “flail rotor 14” may be at approximately 1000 RPM to achieve similar throw distances.

To allow the bale processor 100 to selectively utilize the secondary rotor 140, the secondary rotor 140 may be selectively engaged/disengaged from the power-transmitting device (e.g., through a transmission or movement of the secondary rotor 140) and an internal deflector 150, 150a may selectively remove/provide a partition between the primary and secondary rotors 130, 140. As discussed further below, movement of the internal deflector 150 may be synchronized with engagement/disengagement of the secondary rotor 140.

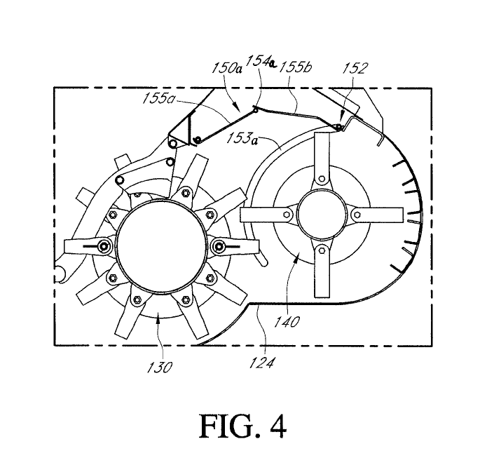

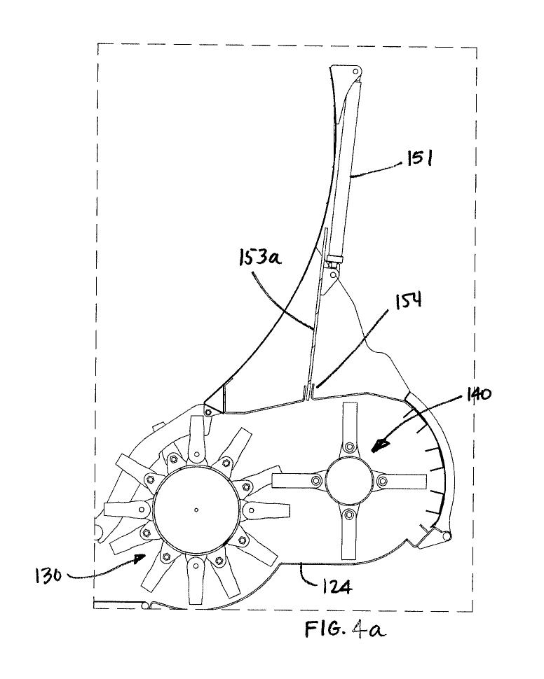

The internal deflector 150, 150a may have numerous configurations and methods of moving between disengaged (FIG. 2, FIG. 2a) and engaged (FIG. 3, 3a) positions. For example, the deflector 150a may have an end 152 that travels along a track 153a (FIG. 4), and a pivot 154a may allow sections 155a, 155b to move relative to one another. In an alternate embodiment, the deflector 150 may include a hydraulic cylinder 151 (or other equivalent device) translationally attached to a deflector plate 153. At a disengaged position (FIG. 2a) the hydraulic cylinder 151 holds the deflector plate 153 away from the rotors 130, 140. At an engaged position, the deflector plate 153 passes through opening 154 to rest between the disengaged rotors 130, 140. Particularly in embodiments with intermeshing rotors 130, 140, it may be desirable for the primary and secondary rotors 130, 140 to respectively have flails 132, 142 that fall freely when not in use. FIG. 3 shows the secondary rotor 140 disengaged and the flails 142 falling freely. But even in these embodiments, however, stationary knife sections may form part of the primary rotor 130 or the secondary rotor 140 to create an additional slicing action. For example, stationary knife sections may extend from a twelve o'clock position to a six o'clock position along the secondary rotor 140.

To ensure that the secondary rotor 140 remains disengaged when the internal deflector 150 is in the engaged (or “blocking”) position, the mechanism for disengaging the secondary rotor 140 may be mechanically or electrically (e.g., through sensors and computer programming) linked to the mechanism for moving the internal deflector 150. In one embodiment, a gearbox and driveline mechanism is used to engage/disengage the secondary rotor 140 and move the internal deflector 150.

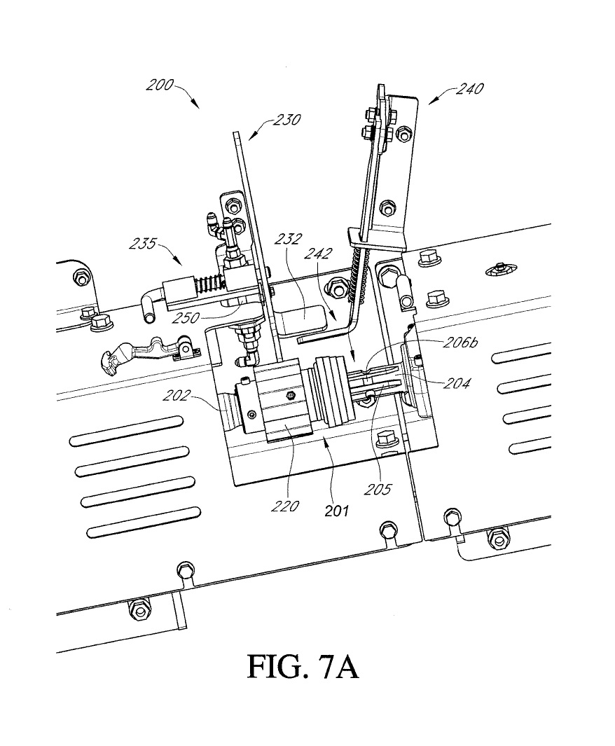

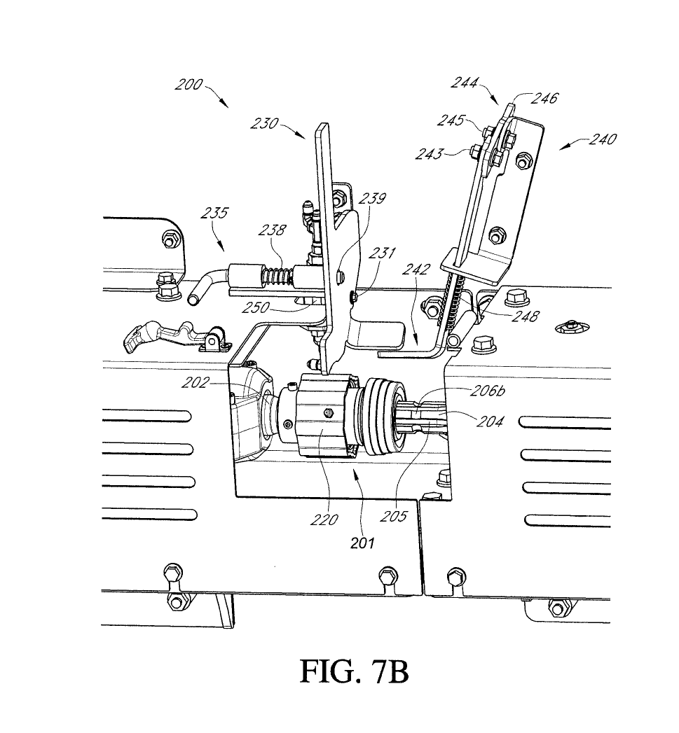

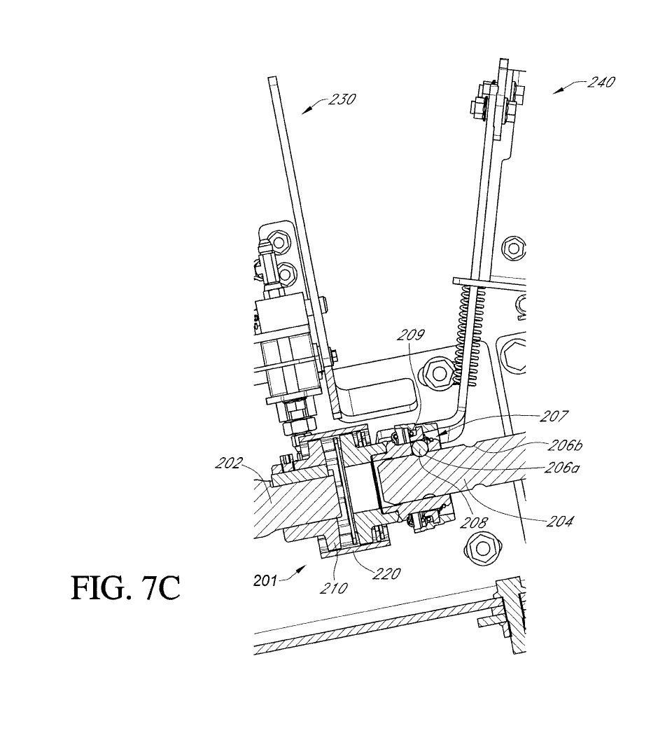

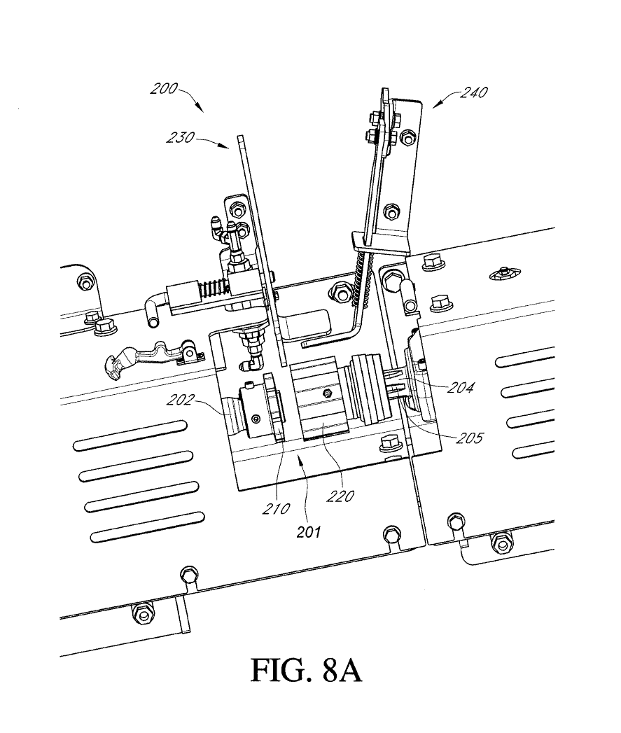

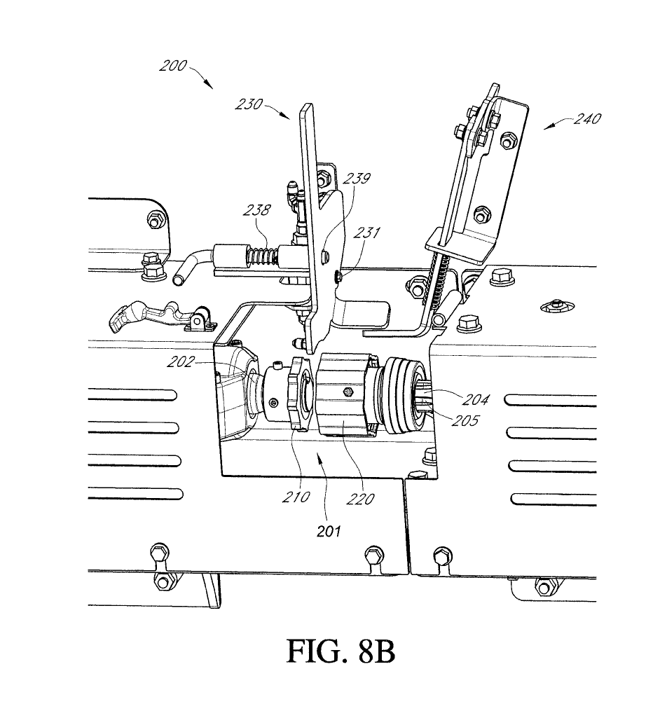

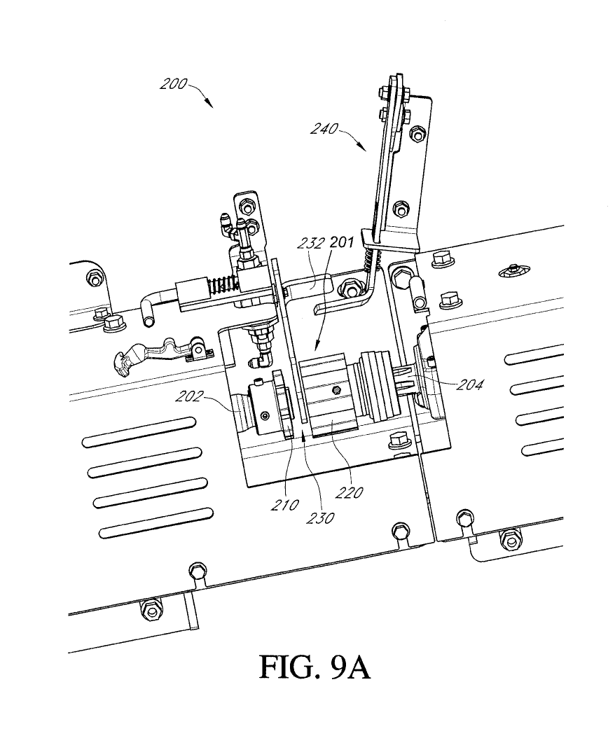

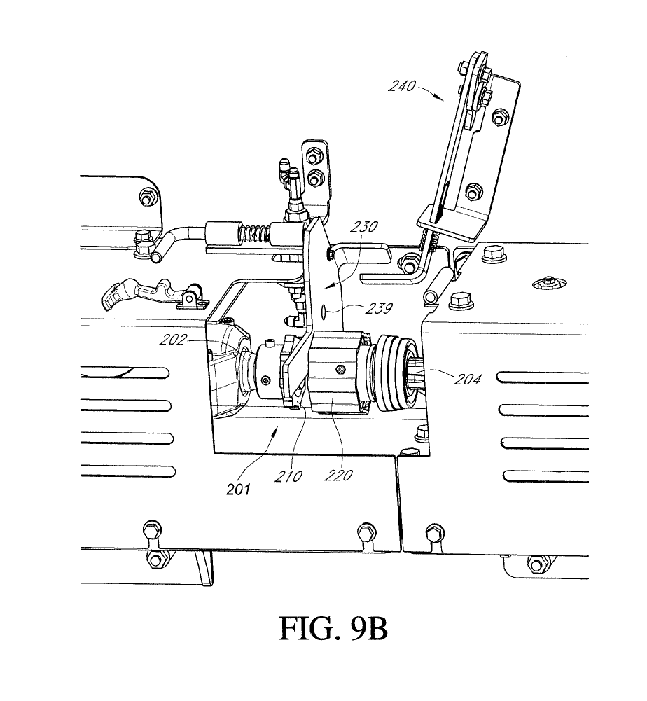

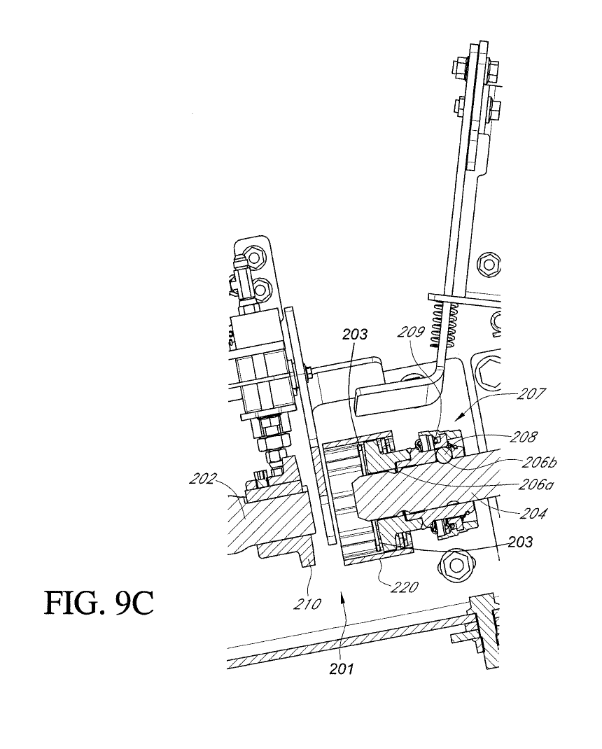

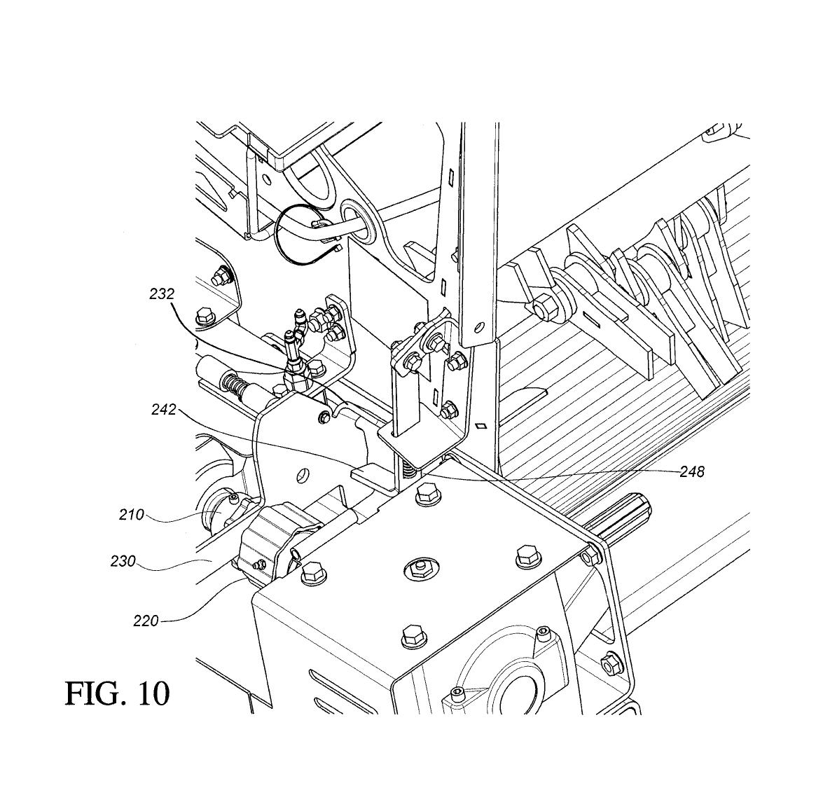

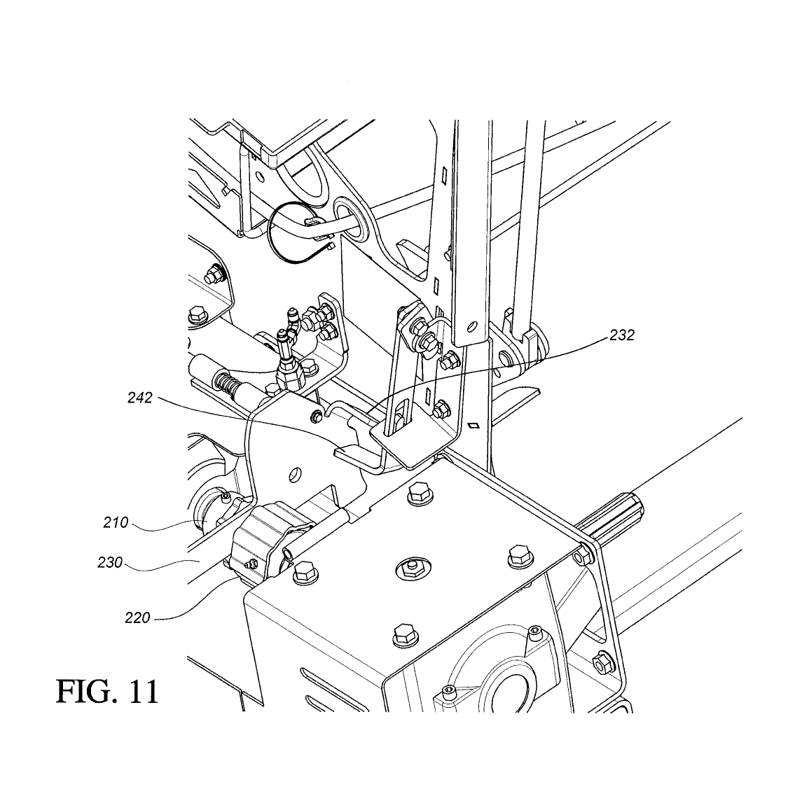

FIGS. 7a through 11 show one power transmission disconnect system 200 incorporated in the bale processor 100. The disconnect system 200 may include a coupler 201 consisting of a driving shaft 202, a driven shaft 204, and corresponding closures 210 and 220, which selectively allows force to be transmitted from the driving shaft 202 to the driven shaft 204, and the driven shaft 204 (directly or indirectly) powers the secondary rotor 140. The coupler 201 is at an engaged position in FIGS. 7a through 7c, an intermediate disengaged position in FIGS. 8a, 8b, and 10 and a fully disengaged position in FIGS. 9a-9c and 11.

The driving shaft 202 has a closure 210 (best shown in FIGS. 8a through 9c) that rotates with the driving shaft 202, and a complementary closure 220 is movable along the driven shaft 204 to selectively interact with (e.g., receive, or be received by) the closure 210. The driven shaft 204 has a splined end, and the complementary closure 220 may have projections that mate with channels 205 such that the closure 220 may slide along the driven shaft 204. The driven shaft 204 further includes depressions 206a, 206b, and a detent 207 (e.g., a ball or ring 208 biased by a spring 209, as shown in FIG. 9c) may cooperate with the depressions 206a, 206b to temporarily bias the closure 220 at the engaged and disengaged positions (FIG. 7c, engaged; FIG. 9c, disengaged).

The coupler 201 may be configured to correct for misalignment of the shafts 202 and 204 when in an engaged position. As noted above, the closure 220 slides axially along the shaft 204, and specifically along channels 205 to move the coupler 201 between engaged and disengaged positions. However, in the engaged position, it is common for shafts 202 and 204 to be slightly misaligned (i.e., the distance between the shafts centers of rotation measured at the plane of power transmission), often leading to premature wear or failure of the coupler 201, as well as less than optimal performance of the machine. To correct for misalignment of the shafts 204 and 205, the closure 220 may be equipped with a snap ring 203 which allows the closure 220 to be radially adjustable (or essentially float) on the shaft 204. To move from the disengaged position to the engaged position, the closure 210 is oriented such that it engages with the closure 220. Closure 220 can radially shift on the shaft 204 in any direction to correct for parallel misalignment of shafts 202 and 204, thus reducing the forces created by shaft misalignment. Adjustment of the closure 220 on the shaft 204 may correct at least as much as 0.125″ of axial misalignment of the shafts 202 and 204, though the closure 220 may be configured to correct a greater degree of misalignment.

The disconnect system 200 further includes a partition 230 selectively movable between a dividing position (FIGS. 9a through 11) and a neutral position (FIGS. 7a through 8b), and a lock 235 prevents the partition 230 from undesirably moving from the neutral position. More particularly, the partition 230 rotates about axis 231 and a spring-loaded pin 238 interacts with a hole 239 (FIG. 7b) to maintain the partition 230 at the neutral position.

An automatic safety 240 has an interference portion 242 pivotably coupled to an actuation portion 244 (i.e., at axis 243), and the actuation portion 244 is rotatable about axis 245. A spring 248 biases the interference portion 242 downwardly such that the interference portion 242 does not interact with corresponding structure 232 of the partition 230 (FIG. 10) and such that the partition 230 is rotatable from the dividing position to the neutral position. The actuation portion 244 further includes an end 246 that may be moved by lowering the internal deflector 150. More particularly, as shown in FIG. 11, lowering the internal deflector 150 forces the actuation portion 244 to pivot about the axis 245 (due to force on the end 246 imparted by the internal deflector 150), overcoming the spring 248 and moving the interference portion 242 upwardly such that the interference portion 242 interacts with structure 232 to prevent the partition 230 from rotating from the dividing position to the neutral position. Engaging the automatic safety 240 with the partition 230 when the internal deflector 150 is in the lowered position as described above ensures that the secondary rotor 140 is inoperable, thus preventing damage.

A hydraulic or pneumatic valve 250 (e.g., a ball valve) may be automatically actuated by rotation of the partition 230 to allow the deflector 150 to be raised and lowered when the partition 230 is moved to the dividing position. When the partition 230 is in the dividing position, the ball valve 250 is open, allowing hydraulic flow to the cylinders that allow for actuation of the deflector 150. When the partition 230 is in the neutral position, the ball valve 250 is closed, preventing hydraulic flow to the deflector 150, and therefore locking the deflector 150 in place.

So the disconnect system 200 may start at the engaged position (FIGS. 7a through 7c), such that the closures 210, 220 interact with one another to transfer force, the partition 230 is at the neutral position, and the automatic safety 240 is clear of the partition 230. While the disconnect system 200 is at the engaged position, force is transferred from the driving shaft 202 to the driven shaft 204 (via the closures 210, 220) to ultimately operate the secondary rotor 140, and the internal deflector 150 is positioned such that material may travel from the primary rotor 130 to the secondary rotor 140.

To move to the disconnect system 200 to the disengaged position (FIGS. 9a through 9c), the driving shaft 202 is stopped, and the closure 220 is moved along the driven shaft 204 (and specifically along the channels 205) to separate the closure 220 from the closure 210. In moving the closure 220, the biasing force between the detent 207 and the depression 206a (FIG. 7c) is overcome, and the detent is subsequently seated in the depression 206b (FIG. 9c). This brings the disconnect system 200 to the intermediate disengaged position shown in FIGS. 8a and 8b. Next, the pin 238 is removed from the hole 239, allowing the partition 230 to rotate about the axis 231 to the dividing position (FIGS. 9a through 9c); when at the dividing position, the partition 230 physically prevents the closures 210, 220 from mating together.

Rotating the partition 230 automatically actuates the valve 250, which in turn allows the deflector 150 to be lowered. Lowering the deflector 150 moves the interference portion 242 of the automatic safety 240 to prevent the partition 230 from rotating from the dividing position to the neutral position, as described above and shown in FIG. 11. This ensures that the driven shaft 204 (and thus the secondary rotor 140) cannot be actuated when the deflector 150 is lowered.

To return the disconnect system 200 to the engaged position (FIGS. 7a through 7c), the deflector 150 is raised, allowing the spring 248 to separate the interference portion 242 from the structure 232 of the partition 230 (FIGS. 9a through 9c). The partition 230 is then rotated to the neutral position, and the pin 238 interacts with the hole 239 to maintain the partition 230 at the neutral position (FIGS. 8a and 8b). Rotation of the partition 230 automatically closes the valve 250, which ensures that the deflector 150 is not lowered. Finally, the closure 220 is moved along the driven shaft 204 (and specifically along the channels 205) to mate the closure 220 with the closure 210. In moving the closure 220, the biasing force between the detent 207 and the depression 206a (FIG. 9c) is overcome, and the detent 207 is subsequently seated in the depression 206a (FIG. 7c). With the disconnect system 200 at the engaged position, force is again transferred from the driving shaft 202 to the driven shaft 204 via the disconnect system 200.

Attention is now directed to use of the overall bale processor 100. After the primary rotor 130 chops bale filamentary material from a bale in the hopper 110 as described above, the chopped bale filamentary material typically passes from the primary rotor 130 to the secondary rotor 140 (FIG. 2). By traveling in the same direction as the primary rotor 130 (e.g., clockwise in FIG. 2), the secondary rotor 140 further chops the bale filamentary material and causes the bale filamentary material to change direction (e.g., from traveling downwardly about the axis 131 to traveling upwardly and clockwise about the axis 141). The bale filamentary material then rotates back to the primary rotor 130, where it is chopped still further and resumes its travel about the axis 131 to be discharged through the discharge opening 160. The described arrangement of the processing section 120 causes the bale filamentary material to be chopped three distinct times (twice by the primary rotor 130 and once by the secondary rotor 140) and may provide substantial reductions in bale filamentary material length in relatively short order.

Cut lengths of approximately three inches and under may be desirable in various applications. For example, forage must generally be no longer than three inches to be used in a Total Mixed Ration (TMR) mixer wagon. Similarly, some methods of biomass processing of bale filamentary material may benefit from relatively small cut lengths. Yet such a fine cut is not always necessary or desirable. When a fine cut is not needed, the secondary rotor 140 may be disengaged and the internal deflector 150 may be moved to the blocking position (FIGS. 3 and 11) as discussed above. In this arrangement, after the primary rotor 130 chops bale filamentary material from a bale in the hopper 110 as described above, the chopped bale filamentary material rotates with the primary rotor 130 about the axis 131 and is discharged through the discharge opening 160 without being impeded by the secondary rotor 140.

An operator may perform maintenance on the primary rotor 130 through the discharge opening 160, and the secondary rotor 140 may be accessed (e.g., from a standing position) by removing an external portion of the processing section 120.

In use, when the closures 220 and 210 are engaged, the internal deflector 150 is hydraulically locked out from movement via ball valve 250 and the partition 230, which is connected to the ball valve 250, cannot be rotated to actuate the ball valve 250. Once the closure 220 is disengaged from closure 210, the partition 230 may be rotated into the dividing position, thereby blocking engagement of closures 210 and 220. With the partition 230 in the dividing position, the hydraulic circuit (i.e., ball valve 250) used to operate the internal deflector 150 is opened. Internal deflector 150 may then be actuated to the lowered position. As the internal deflector 150 is lowered, automatic safety 240 is mechanically actuated thereby moving the interference portion 242 into an interference position with the partition's 230 corresponding feature 232. The interference position prevents the partition 230 from being moved into the neutral position at all times when the internal deflector 1450 is in the lowered position.

When the closures 220 and 210 are disengaged, the partition 230 prevents connection of closures 220 and 210. The closure 220 cannot be connected to closure 210 until the partition 230 is rotated into the neutral position. The partition 230 cannot be rotated into the neutral position until the internal deflector 150 is raised. Once the internal deflector 150 is raised, the interference portion 242 is spring-returned to a lowered position, which allows the partition 230 to rotate to the neutral position thus closing the ball valve 230 and allowing closures 220 and 210 to be connected. With closures 220 and 210 in an engaged position, operation of the secondary rotor 140 may commence.

Many different arrangements of the various components depicted, as well as components not shown, are possible without departing from the spirit and scope of the present invention. For example, the driving and driven shafts 202, 204 may be reversed such that the closure 210 is positioned along the driven shaft 204 and the closure 220 is positioned along the driving shaft 202. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. The specific configurations and contours set forth in the accompanying drawings are illustrative and not limiting.

1. A disconnect system for selectively transmitting force between first and second shafts, the disconnect system comprising:
a first closure configured to rotate with the first shaft; and
a second closure configured to rotate with the second shaft, the second closure being movable along the second shaft to selectively engage the first closure;
wherein the second closure has a detent respectively operable with proximal and distal depressions of the second shaft, the first and second closures being engaged with one another when the detent operates with the proximal depression, the first and second closures being disengaged from one another when the detent operates with the distal depression, respective operation of the detent with the proximal and distal depressions biasing the second closure from moving along the second shaft.

2. The disconnect system of claim 1, wherein the second shaft has a channel and the second closure has a projection that mates with the channel, whereby the second closure is rotatably fixed relative to the second shaft.

3. The disconnect system of claim 1, further comprising:
a partition movable between a dividing position and a neutral position; and
a lock selectively maintaining the partition at the neutral position;
wherein the second closure is movable along the second shaft when the partition is at the neutral position; and
wherein the partition is between the first and second closures such that the first and second closures cannot be engaged with one another when the partition is at the dividing position.

4. The disconnect system of claim 3, further comprising an automatic safety selectably restricting the partition from moving from the dividing position.

5. The disconnect system of claim 1, further comprising:
a partition movable between a dividing position and a neutral position; and
a lock selectively maintaining the partition at the neutral position;
wherein the detent is movable between the proximal and distal depressions when the partition is at the neutral position; and
wherein the partition is between the first and second closures such that the detent cannot move from the distal depression to the proximal depression when the partition is at the dividing position.

6. The disconnect system of claim 3, further comprising a valve actuated by movement of the partition.

7. A bale processor, comprising:
a hopper for receiving a bale of baled material;
a discharge opening for outputting chopped material;
a processing section having primary and secondary rotors; the primary rotor having an axis of rotation and being rotatable to chop the material from the bale received in the hopper; the secondary rotor being rotatable to chop the material after being chopped by the primary rotor; the secondary rotor being offset from the primary rotor such that the primary rotor is between the secondary rotor and the discharge opening; and
a disconnect system for selectively transmitting force between first and second shafts, the disconnect system comprising:
a first closure fixed along and rotatable with the first shaft;
a second closure rotatable with the second shaft, the second closure being movable along the second shaft such that the first and second closures selectively engage one another, engagement of the first and second closures causing rotation of the first shaft to be transmitted to the second shaft whereby the secondary rotor is operable, rotation of the first shaft not being transmitted to the second shaft when the first and second closures are disengaged from one another; and
a partition movable between a dividing position and a neutral position, the second closure being movable along the second shaft when the partition is at the neutral position, the partition being between the first and second closures such that the first and second closures cannot be engaged with one another when the partition is at the dividing position.

8. The bale processor of claim 7, further comprising an internal deflector movable to:
(a) allow generally unobstructed passage between the primary rotor and the secondary rotor when the secondary rotor is operable; and
(b) shield the secondary rotor from the primary rotor when the secondary rotor is not operable, such that chopped material passes from the primary rotor to the discharge opening without encountering the secondary rotor.

9. The bale processor of claim 8, further comprising an automatic safety having an interference portion pivotably coupled to an actuation portion, a spring biasing the automatic safety such that the interference portion is clear of the partition, the actuation portion being located such that the internal deflector moves the actuation portion and overcomes the spring as the internal deflector moves to shield the secondary rotor.

10. The bale processor of claim 9, wherein:
the second shaft has proximal and distal depressions; and
the second closure has a detent respectively operable with the proximal and distal depressions, the first and second closures being engaged with one another when the detent operates with the proximal depression, the first and second closures being disengaged from one another when the detent operates with the distal depression, respective operation of the detent with the proximal and distal depressions biasing the second closure from moving along the second shaft.

11. The bale processor of claim 10, further comprising a lock selectively maintaining the partition at the neutral position.

12. The bale processor of claim 10, further comprising an internal deflector movable between:
one position allowing generally unobstructed passage between the primary rotor and the secondary rotor; and
another position shielding the secondary rotor from the primary rotor such that chopped material passes from the primary rotor to the discharge opening without encountering the secondary rotor.

13. The bale processor of claim 12, further comprising an automatic safety having an interference portion pivotably coupled to an actuation portion, a spring biasing the automatic safety such that the interference portion is clear of the partition, the actuation portion being located such that the internal deflector moves the actuation portion and overcomes the spring as the internal deflector moves to shield the secondary rotor.

14. The bale processor of claim 13, wherein:
the second shaft has proximal and distal depressions; and
the second closure has a detent respectively operable with the proximal and distal depressions, the first and second closures being engaged with one another when the detent operates with the proximal depression, the first and second closures being disengaged from one another when the detent operates with the distal depression, respective operation of the detent with the proximal and distal depressions biasing the second closure from moving along the second shaft.

15. The bale processor of claim 14, further comprising a lock selectively maintaining the partition at the neutral position;

16. The bale processor of claim 7, wherein:
the second shaft has proximal and distal depressions; and
the second closure has a detent respectively operable with the proximal and distal depressions, the first and second closures being engaged with one another when the detent operates with the proximal depression, the first and second closures being disengaged from one another when the detent operates with the distal depression, respective operation of the detent with the proximal and distal depressions biasing the second closure from moving along the second shaft.

17. The disconnect system of claim 7, further comprising a valve actuated by movement of the partition.

18. The bale processor of claim 7, wherein the primary rotor and the secondary rotor intermesh when the primary and secondary rotors rotate.

19. The bale processor of claim 7, wherein the primary rotor is a first flail rotor, and wherein the secondary rotor is a second flail rotor.

20. A bale processor, comprising:
a hopper for receiving a bale of baled material;
a discharge opening for outputting chopped material;
a processing section having primary and secondary rotors; the primary rotor having an axis of rotation and being rotatable to chop the material from the bale received in the hopper; the secondary rotor being rotatable to chop the material after being chopped by the primary rotor; the secondary rotor being offset from the primary rotor such that the primary rotor is between the secondary rotor and the discharge opening; and
a disconnect system for selectively transmitting force between first and second shafts, the disconnect system comprising:
a first closure fixed along and rotatable with the first shaft; and
a second closure rotatable with the second shaft, the second closure being movable along the second shaft such that the first and second closures selectively engage one another, engagement of the first and second closures causing rotation of the first shaft to be transmitted to the second shaft whereby the secondary rotor is operable, rotation of the first shaft not being transmitted to the second shaft when the first and second closures are disengaged from one another;
wherein the second shaft has proximal and distal depressions; and
wherein the second closure has a detent respectively operable with the proximal and distal depressions, the first and second closures being engaged with one another when the detent operates with the proximal depression, the first and second closures being disengaged from one another when the detent operates with the distal depression, respective operation of the detent with the proximal and distal depressions biasing the second closure from moving along the second shaft.

21. A disconnect system for selectively transmitting force between first and second shafts, the disconnect system comprising:
a first closure configured to rotate with the first shaft; and
a second closure configured to rotate with the second shaft, the second closure being movable along the second shaft to selectively engage the first closure;
wherein:
the first shaft and the second shaft are axially misaligned;
the second closure is configured to adjust in a radial direction on the second shaft when the second closure selectively engages the first closure to correct for the axial misalignment of the first and second shaft; and
the second closure has a detent respectively operable with proximal and distal depressions of the second shaft, the first and second closures being engaged with one another when the detent operates with the proximal depression, the first and second closures being disengaged from one another when the detent operates with the distal depression, respective operation of the detent with the proximal and distal depressions biasing the second closure from moving along the second shaft.
